(19) United States
(12) Patent Application Publication
(10) Pub. No.: US 2019/0311274 A1
(43) Pub. Date: Oct. 10, 2019

(54) Tracking Potentially Lost Items Without Beacon Tags

(71) Applicant: International Business Machines Corporation, Armonk, NY (US)

(72) Inventors: Donna K. Byron, Petersham, MA (US); Srinavasa Gadde, Belmont, CA (US); Ashok Kumar, North Chelmsford, MA (US); Timothy P. Winkler, Clinton, MA (US)

(21) Appl. No.: 15/945,924

(22) Filed: Apr. 5, 2018

(51) Int. Cl. G06N 5/02; G06N 7/00; G06F 17/30; G06N 99/00

(52) U.S. Cl. CPC G06N 5/022; G06N 99/005; G06F 17/3043; G06N 7/005

(57) ABSTRACT

An approach is provided for performing an item tracking operation. The item tracking operation includes defining a knowledge model where the knowledge model correlates usage of an item away from a parked location with other locations visited by a user. The item tracking operation also includes tracking the item when the item is removed from the parked location where the tracking includes determining when the item is moved to a particular location. The item tracking operation also includes determining whether the item is returned to the parked location and notifying the user when the item was not returned to the parked location where the notifying calculates a probability that the item was left behind at the particular location.

### BACKGROUND OF THE INVENTION

### Field of the Invention

The present invention relates in general to the field of computers and similar technologies, and in particular to software utilized in this field. Still more particularly, it relates to a method, system and computer-usable medium for tracking items without the need for beacon tags.

### Description of the Related Art

Personal items may be lost or misplaced either at home or when away from home. It can be annoying to leave an item somewhere, then by the time it is noticed missing not be able to remember where the item might be. Known solutions to this issue often rely on marking items with transmitter beacons. These transmitter beacon based solutions can have a limited range and are often bulky, can run out of power, and/or may not be attachable to all items that one would like to avoid losing such as a wedding ring.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating knowledge management systems which may take an input, analyze it, and return results indicative of the most probable results to the input. Knowledge management systems provide automated mechanisms for searching through a knowledge base with numerous sources of content, e.g., electronic documents, and analyze them with regard to an input to determine a result and a confidence measure as to how accurate the result is in relation to the input.

### SUMMARY OF THE INVENTION

A method, system and computer-usable medium are disclosed for performing an item tracking operation, comprising: defining a knowledge model, the knowledge model correlating usage of an item away from a parked location with other locations visited by the user; tracking the item when the item is removed from the parked location, the tracking including determine when the item is moved to a particular location; determining whether the item is returned to the parked location; and, notifying the user when the item was not returned to the parked location, the notifying calculating a probability that an item was left behind at the particular location.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an illustrative embodiment of a knowledge manager system instantiated in a distributed knowledge manager environment.

FIG. 2 shows a simplified block diagram of an information handling system capable of performing computing operations.

FIG. 3 shows a block diagram of an item tracking environment.

FIG. 4 shows a flow chart of the operation of the item tracking operation.

FIG. 5 shows a flow chart of an example event flow of the item tracking operation.

### DETAILED DESCRIPTION

A method, system and computer-usable performing an item tracking operation are disclosed. Such an item tracking operation track items (such as personal items) so that they can be recovered if lost, without the need for attaching a tracking beacon on the item. Such an item tracking operation also avoids reliance on special-purpose sensors to track the user's body position or the location of the item. In certain embodiments, the item tracking operation is tunable to the alerting sensitivity of the user. In certain embodiments, the item tracking operation trains itself over time for potential places where the user is likely to leave items.

Various aspects of the disclosure utilize the IBM Watson™ knowledge management system available from International Business Machines (IBM) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA technology used for hypothesis generation, massive evidence gathering, analysis, and scoring. DeepQA takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

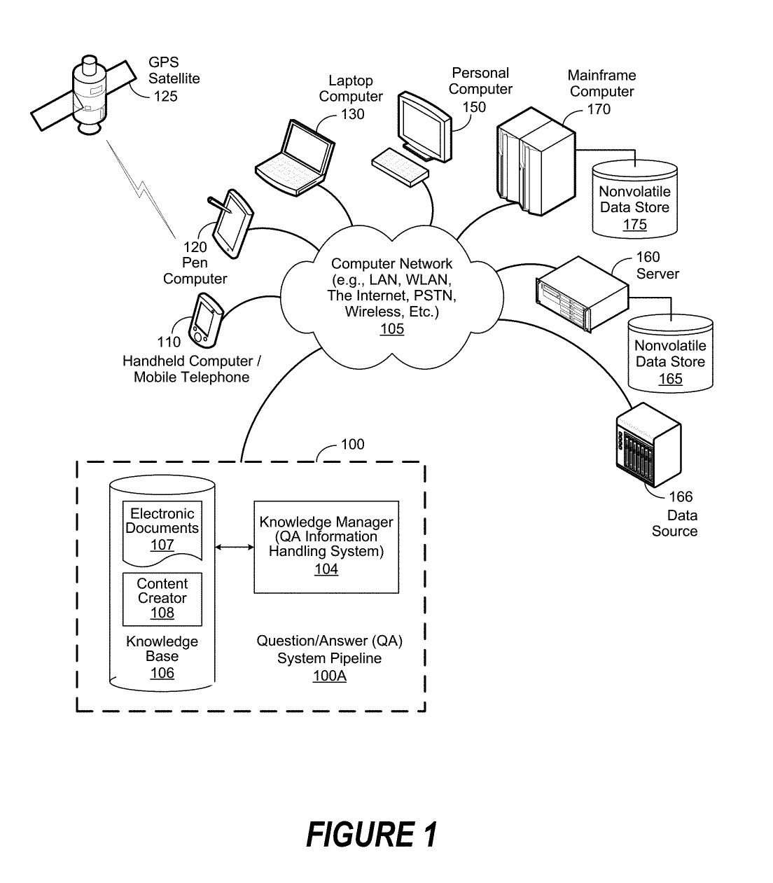

FIG. 1 depicts a schematic diagram of one illustrative embodiment of a knowledge manager system (e.g., a question/answer (QA)) system 100 which is instantiated in a distributed knowledge manager environment 102. One example of a question/answer generation which may be used in conjunction with the principles described herein is described in U.S. Patent Application Publication No. 2011/0125734, which is herein incorporated by reference in its entirety. Knowledge manager 100 may include a knowledge manager information handling system 104 (comprising one or more processors and one or more memories, and potentially any other computing device elements generally known in the art including buses, storage devices, communication interfaces, and the like)coupled to a network 105. The environment 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and environment 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 105, a knowledge base 106 which can include a corpus of electronic documents or other data, a content creator 108, content users, and other possible sources of input. In various embodiments, the other possible sources of input can include location information. In one embodiment, some or all of the inputs to knowledge manager 100 may be routed through the network 105. The various computing devices 104 on the network 105 may include access points for content creators and content users. Some of the computing devices 104 may include devices for a database storing the corpus of data. The network 105 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection (represented as network 105), and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers. In various embodiments, the one or more answers take into account location information.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

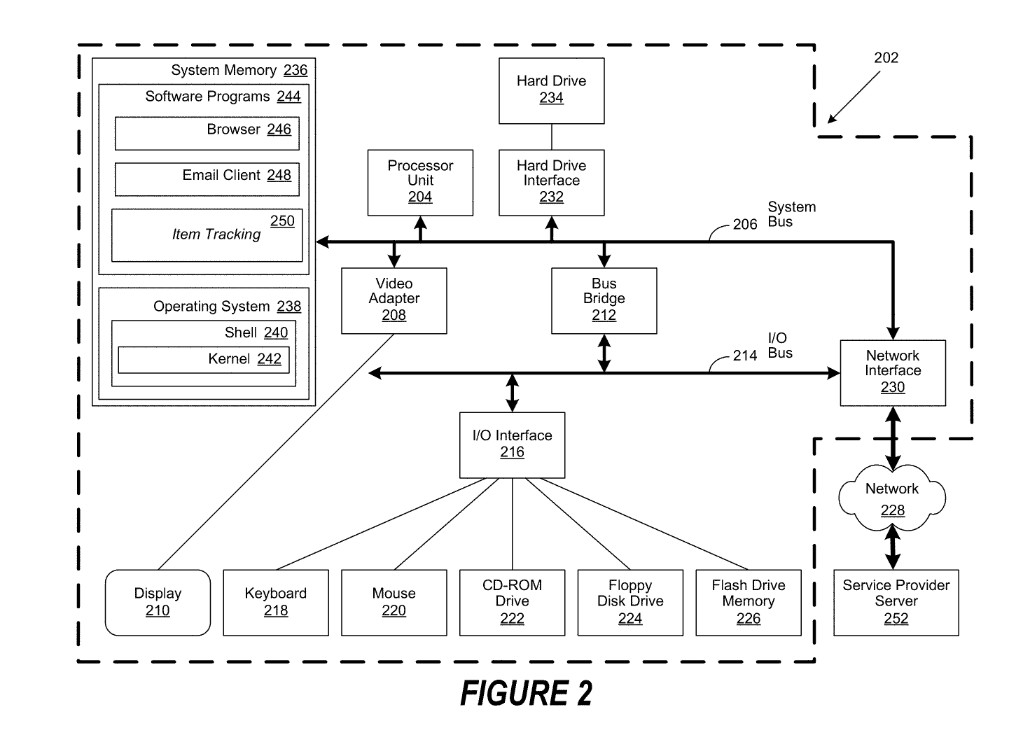

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. In certain embodiments, the location information is determined through the use of a Geographical Positioning System (GPS) satellite 125. In these embodiments, a handheld computer or mobile telephone 110, or other device, uses signals transmitted by the GPS satellite 125 to generate location information, which in turn is provided via the network 105 to the knowledge manager system 100 for processing. As shown, the various information handling systems can be networked together using computer network 100. Types of computer network 105 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates an information handling system 202, more particularly, a processor and common components, which is a simplified example of a computer system capable of performing the computing operations described herein. Information handling system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information handling system 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information handling system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information handling system 202) to send and receive network messages to the Internet using HyperText Transfer Protocol (HTTP) messaging, thus enabling communication with service provider server 252. In various embodiments, software programs 244 may also include an item tracking system 250. In these and other embodiments, the item tracking system 250 includes code for implementing the processes described hereinbelow. In one embodiment, the information handling system 202 is able to download the item tracking system 250 from a service provider server 252.

The hardware elements depicted in the information handling system 202 are not intended to be exhaustive, but rather are representative to highlight components used by the present invention. For instance, the information handling system 202 may include alternate memory storage devices such as magnetic cassettes, Digital Versatile Disks (DVDs), Bernoulli cartridges, and the like. These and other variations are intended to be within the spirit, scope and intent of the present invention.

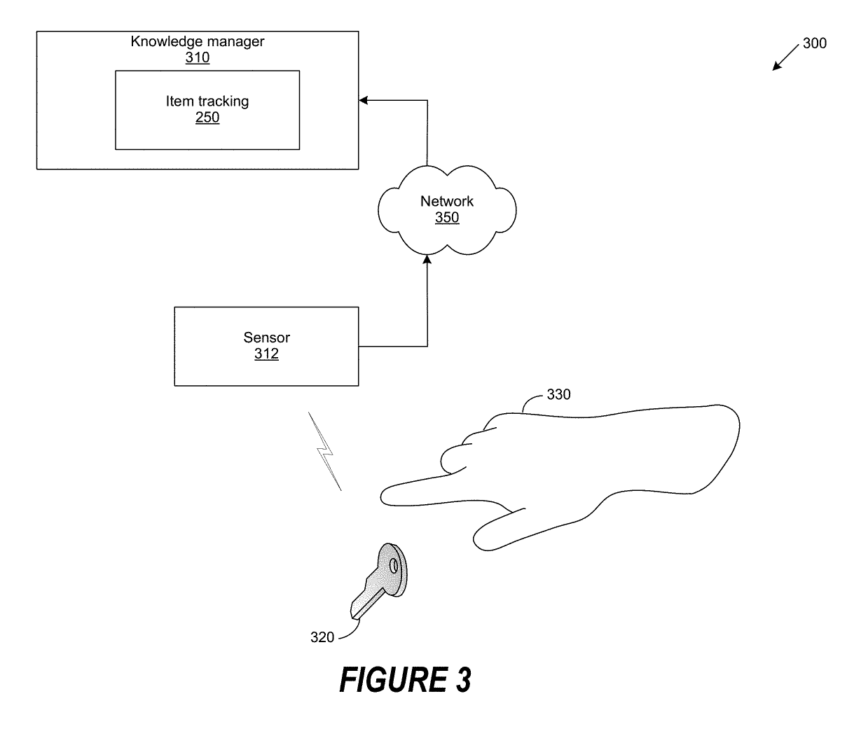

FIG. 3 shows a block diagram of an item tracking environment 300. The item tracking environment includes an item tracking system 305 which may be executing within a knowledge manager 310 (such as knowledge manager 100), a sensor 312 communicating with the item tracking system 250 as well as an item 320 and a user 330. In various embodiments, the sensor 312 is a general purpose sensor easily associated with the user. For example, in certain embodiments, the sensor is included within a mobile device. In certain embodiments, the sensor may include an internet of things (IoT) type sensor such as a camera, a motion detector, a door sensor, etc. The sensor may communicate with the knowledge manager 310 and the item tracking system 250 via a network 350.

The item tracking system 250 performs an item tracking operation. The item tracking operation track items (such as personal items) so that they can be recovered if misplaced, without the need for attaching a tracking beacon on the item. Such an item tracking operation also avoids reliance on special-purpose sensors to track the user's body position or the location of the item. In certain embodiments, the item tracking operation is tunable to the alerting sensitivity of the user. In certain embodiments, the item tracking operation trains itself over time for potential places where the user is likely to leave items.

The item tracking operation includes an appreciation that for each user, the set of items to track is often relatively small (e.g., fewer than 5 items). The item tracking operation also includes an appreciation that for each user, the type of items to be tracked may vary. In various embodiments, the number of items to be tracked and the type of items to be tracked is customizable. Some users may need assistance tracking keys while others have no problem with keys but may often misplace a clothing item such as a jacket. Some people may often misplace their cell phone, but others can reliably use the cell phone as a geo-locator.

An example embodiment has minimal reliance on hardware used for the purpose of performing the item tracking operation. In various embodiments, the hardware may include sensors to detect the tracked items in their ‘home’ location. This can be a video scene camera such as those used at the entryway of the home, RFID sensors, etc.

The item tracking operation uses physical modeling to detect when an item is placed in use (e.g., removed from its parked location). In various embodiments, the physical modeling includes one or more of computer vision-based detection, training hand-movement sensors to know that an item is moved (e.g., when an item is removed from table, placed in pocket, etc.) or visual analysis of the user as they leave home (e.g., was the user wearing a coat or backpack as they left the house).

The item tracking operation can use optional sensors to detect fine-grained movement of hands when using an object. For example, the combination of a hand-based sensor such as a ring and another sensor in a fixed location on the body can be used to model manipulation tasks such as removing credit card from the wallet.

The item tracking operation can uses geo-sensors to track locations visited by the user. This may be relayed from a smart phone's GPS location device or other item that is not so easily misplaced, such as a piercing/implant or ring. Such a permanently-attached item can also used to sense and track movement within the home.

The item location operation uses a mixture of evidence to track usage of an item. Some of the evidence can be high-confidence evidence (e.g., RFID readings) and other evidence can be of varying confidence from action-based inference, such as modeling ‘placing keys in pocket’ from hand movements or audio-visual inputs. As the user moves throughout a sequence of events, the item tracking operation updates the probability of an item tracking Boolean value. The item tracking Boolean value indicates whether the item is still with the user or not with the user.

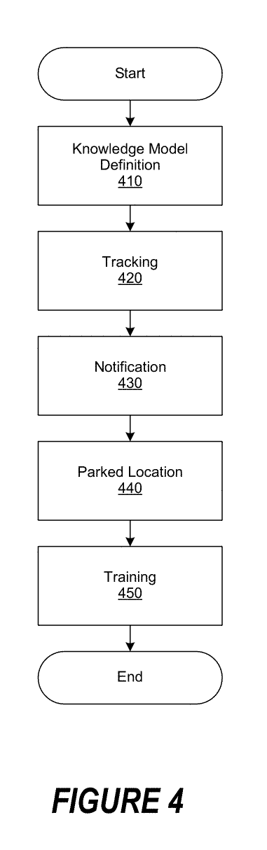

Referring to FIG. 4, a flow chart of the operation of the item tracking operation 400 is shown. More specifically, the item tracking operation 400 includes a plurality of processing phases including one or more of a knowledge model definition phase 410, a tracking phase 420, a notification phase 430, a parked location phase 440 and a training phase 440.

During the knowledge model definition phase 410 the item tracking operation populates a data resource that correlates usage of an item away from a parked location with locations and/or occasions of use. The knowledge model definition phase, the item tracking operation also calculates a probability that an item may be left behind at a particular location. Calculation of the probability takes into account the appreciation that a probability of losing different items may be different due to locations associated with the item or occasions of use of the item. For example, locations where apparel items (e.g., coats) are misplaced would likely have a different probability distribution than locations where informational items (e.g., insurance cards) are misplaced or where financial items (e.g., credit or debit cards) are misplaced.

The item tracking operation takes into account that each type of item has different features useful in the tracking, for example coats are sensitive to weather/temperature features while keys are sensitive to transportation features. In various embodiments, the item types can include a financial item type, a clothing item type, an accessory item type, jewelry item type and a functional item type. A financial item type is associated with any item used when performing a financial transaction such as a checkbook, a charge card, cash, etc. A clothing item type is associated with any garment item such as jackets, shirts, trousers, shoes, hats, etc. An accessory item type is associated with any item which adds to the convenience or effectiveness of something else such as a wallet, a purse, a backpack, a briefcase, etc. A jewelry item type is associated with any object of precious metal worn for personal adornment. A functional item type is associated with any item which performs a regular function such as mobile device, a key, a key fob, an umbrella, a flashlight, etc. In certain embodiments, more than one item type may be associated with a particular item. For example, a financial item type and a functional item type may be associated with a mobile device or a key fob. In various embodiments, features can include one or more of location features, weather features, transportation features.

When taking into account an item type for a particular user a financial item such as a checkbook may have a location feature which indicates the financial item is often be used at a bank or grocery store. For a particular user an accessory item such as a wallet may have a location feature which indicates the accessory item is often used at one or a plurality of retail locations. For a particular user a functional item such as a key may travel with the user whenever the user leaves a particular base location. For a particular user a clothing item such as a jacket may be used when the user is outside during times when the weather meets certain conditions.

Additionally, during the knowledge model definition phase 410 a setup operation may be performed. During the setup operation, a user selects an item to be tracked. In certain embodiments, during the setup operation an application such as a mobile device application or a computer application, trains the item tracking system for object recognition of the selected item to be tracked. In certain embodiments, the application also trains the item tracking system regarding regularly occurring locations of the item to be tracked. For example, the application might determine that when the user is located in a particular base location, the item is regularly found in a bowl on a counter of a kitchen of the particular base location. In certain embodiments, the application may use computer vision-based detection when training the item tracking system. In certain embodiments, the application may use a combination of sensors to define a parked position (i.e., the location where the item is most often set within the particular base location) of the item to be tracked. For example, the application may use a combination of one or more cameras as well as a radio frequency identifier (RFID) transmitter with a beacon tag, etc.

Additionally, during the knowledge model definition phase 410 a personalization operation may be performed. During the personalization operation a user can set one or more personalization settings associated with tracking the item. For example, the user can determine the sensitivity level at which they want a notification to check whether the object is still with them or has been misplaced. For example, if a confidence value that the user has their ATM card with them falls below 95%, then the item tracking operation might generate an alert indicating the user should check to confirm whether they know the location of the item. In certain embodiments, the personalization options are tunable so as to avoid undesired false alarms.

In various embodiments the alert preferences may be set globally or per item. In certain embodiments, the alert preferences may include a high alert mode of operation. The user may wish to use the high alert mode of operation when they are away from home on a trip, for example. In certain embodiments, the high alert mode of operation can trigger a reminder alert as the user checks out of the hotel or returns a rental car, based on the high probability from the baseline model that these are transitions where items are often misplaced.

The tracking phase 420 includes an initialization operation and a tracking operation. When a user moves an item from its parked position the initialization operation is started. The initialization operation instantiates an active listener that dynamically tracks the probability that the item has been misplaced. In certain embodiments, the active listener executes within a thread of the knowledge manager 100. When the item is returned to the parked position, the instantiation of the active listener is terminated.

The tracking operation tracks the item and updates the probability of the item being misplaced as the user moves about. In certain embodiments the tracking operation uses a geo-fence operation to track the location of the user. For example, the user may be tracked as being in a car on the freeway, at a bank, then back in the car, etc.

In certain embodiments the tracking operation implements an event model that is used to partition the user's activity into intervals, each interval representing an event corresponding to an action of the user. Each interval has a respective set of features such as speed of movement, transportation, activity (e.g. shopping/dining at cafe), location, indoor/outdoor, etc. Each time the user transitions between sub-events, the tracker for each item updates its estimation of whether the item is still with user. For example, exiting a car to enter a business closes an interval of driving to the business and opens an interval of being within the business. With each interval change each item is updated with the probability that it was still with the user during that interval.

Different items can utilize different features for the probability model, for example the fact that user drove their own car is strong evidence that the user had keys with them during the driving interval. The knowledge of whether a user had their coat with them during the driving event can be modeled based on contextual features such as weather, and the confidence at a prior interval (e.g., the camera observed the user wearing the coat as they left the house). The knowledge manager 100 and a knowledge repository are is used to predict usage of the item at each location. An item that was used is more likely to be left. An item used for one subtask but not used for the next subtask (for example checkbook is not needed to drive away from the bank) has an increased likelihood of being misplaced.

In certain embodiments, additional optional on-body sensors may be used to provide additional information regarding an item. For example, the use of an item at a location may be detected via on-body sensors, for example sensing when a user removes a coat, removes a wallet from pocket, etc. In certain embodiments, the probability estimation is also sensitive to whether the user is performing a common or uncommon task, using a distance metric that compares a present event sequence to daily habits or places they often visit.

During the notification phase 430, each time an interval closes and the probability of item with user value is recalculated, the item tracking system 250 decides whether to send the user a notification. The notification level (i.e., the probability that an item is with the user) can be set to particular thresholds per item or overridden by the user.

During the parked location phase 440, the item tracking system determines when an event sequence has been completed. An example of a completed event sequence might be when the user returns home from running errands. When an event sequence has been completed, if items are returned to their parked location the trackers are cleared. If items are not returned, the user is notified of the last known location or shown the probability of item's being left behind in different locations from a certain number of immediately previous interval sequences.

During the training phase 440, the item tracking system 250 is trained from the personal history of the particular user. More specifically, the training involves tuning the probabilities of leaving item in a particular location over time based on the user's particular history. For example if the ATM card is left behind at a particular bank, that information is used for subsequent probability estimations.

One advantage of the present item tracking operation is that special attention is paid not just to locations but to transitions (e.g. when a user exits a car and enters bank, exits the bank and returns to car, etc.). The present tracking operation includes an appreciation that transition points where one activity involved certain items, but the user's attention is already on the next activity that requires a different set of items, is a common reason for losing objects. Accordingly, the present item tracking operation uses a model where different sub-events for different items each have their own feature set to estimate probability.

The item tracking system does not use a tracker on the item to automatically find the item. However, with the present item tracking system by notifying the user that the item was left behind in a timely manner, while their memory is fresh can facilitate recovery of the item without the need for a tracker.

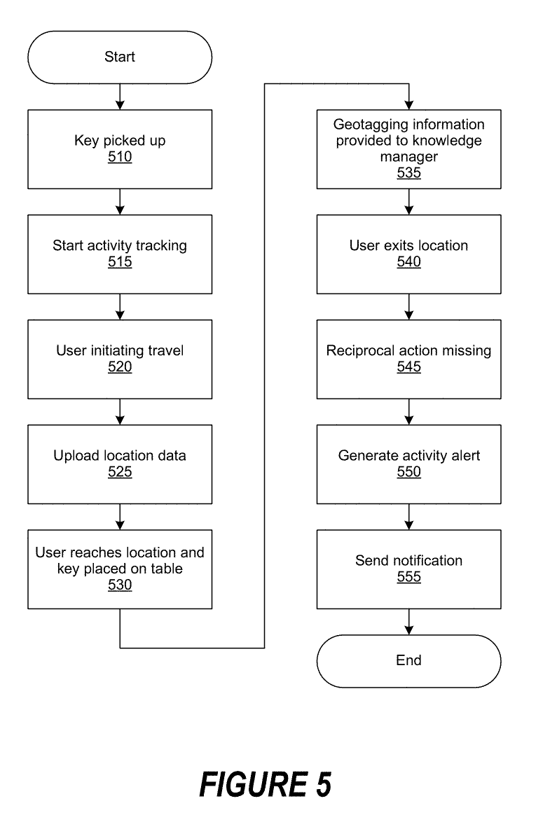

Referring to FIG. 5, a flow chart of an example event flow 500 of the item tracking operation is shown. More specifically, when the item tracking system 250 determines that a user has picked up a key at step 510, activity tracking is started for the key at step 515. Next, when the item tracking system 250 determines that the user has started to travel somewhere at step 520, the location data (such as GPS data) is uploaded to the knowledge manager 100 at step 525. Next, when the user reaches a location (e.g., a coffee shop) and the item tracking system 250 determines that the user has placed the key on a table at step 530, then the geo tagging information is provided to the knowledge manager 100 indicating that the item has be set somewhere other than its base location at step 535. Next, at step 540 when the item tracking system 250 determines that user has exited the location without picking up the key, then the item tracking system 250 determines that the reciprocal action of picking up the key is missing. The item tracking system 250 then indicates that an activity alert should be generated at step 550 and a notification is sent to the user at step 555.

Although the present invention has been described in detail, it should be understood that various changes, substitutions and alterations can be made hereto without departing from the spirit and scope of the invention as defined by the appended claims.

What is claimed is:

1. A computer-implementable method for performing an item tracking operation, comprising:
defining a knowledge model, the knowledge model correlating usage of an item away from a parked location with other locations visited by the user;
tracking the item when the item is removed from the parked location, the tracking including determine when the item is moved to a particular location;
determining whether the item is returned to the parked location; and,
notifying the user when the item was not returned to the parked location, the notifying calculating a probability that an item was left behind at the particular location.

2. The method of claim 1, further comprising:
training the knowledge model, the training comprising tuning the probability of the user leaving the item in the particular location over time based on a particular history of the user.

3. The method of claim 1, wherein:
the knowledge model comprises a plurality of intervals, each interval of the plurality of intervals having a respective set of features.

4. The method of claim 3, wherein:
each time the user transitions between events, the tracking for the item updates an estimation of whether the item is still with user.

5. The method of claim 1, wherein:
the notifying is tunable to change an alerting sensitivity of the user.

6. The method of claim 1, further comprising:
tracking a plurality of items, each of the plurality of items having an associated item type, the tracking the plurality of items taking into account that each associated item type has different features useful when tracking each item.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
defining a knowledge model, the knowledge model correlating usage of an item away from a parked location with other locations visited by the user;
tracking the item when the item is removed from the parked location, the tracking including determine when the item is moved to a particular location;
determining whether the item is returned to the parked location; and,
notifying the user when the item was not returned to the parked location, the notifying calculating a probability that an item was left behind at the particular location.

8. The system of claim 7, wherein the instructions executable by the processor are further configured for:
training the knowledge model, the training comprising tuning the probability of the user leaving the item in the particular location over time based on a particular history of the user.

9. The system of claim 7, wherein:
the knowledge model comprises a plurality of intervals, each interval of the plurality of intervals having a respective set of features.

10. The system of claim 9, wherein:
each time the user transitions between events, the tracking for the item updates an estimation of whether the item is still with user.

11. The system of claim 7, wherein:
the notifying is tunable to change an alerting sensitivity of the user.

12. The system of claim 7, wherein the instructions executable by the processor are further configured for:
tracking a plurality of items, each of the plurality of items having an associated item type, the tracking the plurality of items taking into account that each associated item type has different features useful when tracking each item.

13. A non-transitory, computer-readable storage medium embodying computer program code, the computer program code comprising computer executable instructions configured for:
defining a knowledge model, the knowledge model correlating usage of an item away from a parked location with other locations visited by the user;
tracking the item when the item is removed from the parked location, the tracking including determine when the item is moved to a particular location;
determining whether the item is returned to the parked location; and,
notifying the user when the item was not returned to the parked location, the notifying calculating a probability that an item was left behind at the particular location.

14. The non-transitory, computer-readable storage medium of claim 13, wherein the computer executable instructions are further configured for:
training the knowledge model, the training comprising tuning the probability of the user leaving the item in the particular location over time based on a particular history of the user.

15. The non-transitory, computer-readable storage medium of claim 13, wherein:
the knowledge model comprises a plurality of intervals, each interval of the plurality of intervals having a respective set of features.

16. The non-transitory, computer-readable storage medium of claim 15, wherein:
each time the user transitions between events, the tracking for the item updates an estimation of whether the item is still with user.

17. The non-transitory, computer-readable storage medium of claim 13, wherein:
the notifying is tunable to change an alerting sensitivity of the user.

18. The non-transitory, computer-readable storage medium of claim 13, wherein the computer executable instructions are further configured for:
tracking a plurality of items, each of the plurality of items having an associated item type, the tracking the plurality of items taking into account that each associated item type has different features useful when tracking each item.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
